(19) United States
(12) Patent Application Publication
(10) Pub. No.: US 2010/0262316 A1
(43) Pub. Date: Oct. 14, 2010

(54) Vehicle control apparatus

(75) Inventor: Takumi Nakagawa, Oobu-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-City (JP)

(21) Appl. No.: 12/662,050

(22) Filed: Mar. 30, 2010

(30) Foreign Application Priority Data
Apr. 8, 2009 (JP) 2009-094048

(51) Int. Cl. G06F 19/00

(52) U.S. Cl. 701/1

(57) ABSTRACT

The vehicle control apparatus, which performs vehicle control on a vehicle by issuing commands generated on the basis of results of computations which the vehicle control apparatus performs by use of a plurality of parameters, includes a first section to obtain a vehicle state of the vehicle, and a second section to make, for each of the plurality of the parameters, a determination whether or not the vehicle state has changed in compliance with corresponding at least one of rewrite conditions respectively set for the plurality of the parameters. If the determination is affirmative, the second section rewrites the parameter to a corresponding one of rewrite values respectively assigned to the plurality of the parameters.

### CROSS-REFERENCE TO RELATED APPLICATION

This application is related to Japanese Patent Application No. 2009-94048 filed on Apr. 8, 2009, the contents of which are hereby incorporated by reference.

### BACKGROUND OF THE INVENTION

1. Field of the Invention

The present invention relates to a vehicle control apparatus which performs vehicle control by issuing commands generated on the basis of results of computations which the vehicle control apparatus performs by use of a plurality of parameters.

2. Description of Related Art

There is known a vehicle control system in which a plurality of ECUs (electronic control units) are connected so that they can communicate with one another. For example, refer to Japanese Patent Application Laid-open No. 2008-088913.

Each of the ECUs of the above vehicle control system is configured to rewrite parameters stored in a memory thereof at a timing when a predetermined rewrite condition is satisfied. The timings at which parameters are rewritten may differ from ECU to ECU due to difference in the rewrite conditions among the ECUs. For example, there may be a case where one of the ECUs rewrites parameters when it is connected to a battery, and another one of the ECUs rewrites parameters each time an ignition key of a vehicle is turned on. Meanwhile, there is a demand to integrate a plurality of the ECUs into a single ECU for cost reduction.

However, it should be noted that if ECUs whose parameter-rewrite timings are different from one another are integrated into a single ECU, there may occur a problem that the parameter-rewrite timing of the integrated ECU (for example, the timing when it is connected to the battery, or when the ignition key is turned on) is inconsistent with those of the respective not-integrated ECUs, as a result of which the integrated ECU incorrectly performs a process by use of parameters not yet rewritten, or rewrites parameters although they should not be rewritten.

### SUMMARY OF THE INVENTION

The present invention provides a vehicle control apparatus to perform vehicle control on a vehicle by issuing commands generated on the basis of results of computations which the vehicle control apparatus performs by use of a plurality of parameters, comprising:

a first section to obtain a vehicle state of the vehicle; and

a second section to make, for each of the plurality of the parameters, a determination whether or not the vehicle state has changed in compliance with corresponding at least one of rewrite conditions respectively set for the plurality of the parameters, and if the determination is affirmative, rewrite the parameter to a corresponding one of rewrite values respectively assigned to the plurality of the parameters.

According to the present invention, it is possible to integrate a plurality of ECUs each of which performs computations by use of a plurality of parameters which should be rewritten at predetermined timings into a single ECU which can rewrite the parameters at their respective correct timings.

Other advantages and features of the invention will become apparent from the following description including the drawings and claims.

### BRIEF DESCRIPTION OF THE DRAWINGS

In the accompanying drawings:

FIG. 1A is a block diagram showing a schematic structure of a vehicle control system including a vehicle control ECU as vehicle control apparatus according to an embodiment of the invention;

FIG. 1B is an explanatory view showing a software configuration of the vehicle control ECU;

FIG. 2A is an explanatory view showing a table included in a power source-state database included in the vehicle control ECU;

FIG. 2B is an explanatory view showing a table included in a rewrite-value database included in the vehicle control ECU;

FIG. 3 is a flowchart showing a parameter rewriting process performed by the vehicle control ECU;

FIG. 4A is an explanatory view showing a table included in a modification of the power supply-state database;

FIG. 4B is an explanatory view showing a table included in a modification of the rewrite-value database;

FIG. 5A is an explanatory view showing a table included in another modification of the power supply-state database;

FIG. 5B is an explanatory view showing a table included in still another modification of the power supply-state database; and

FIG. 6 is a flowchart showing a parameter rewriting process performed by a modification of the vehicle control apparatus.

### PREFERRED EMBODIMENTS OF THE INVENTION

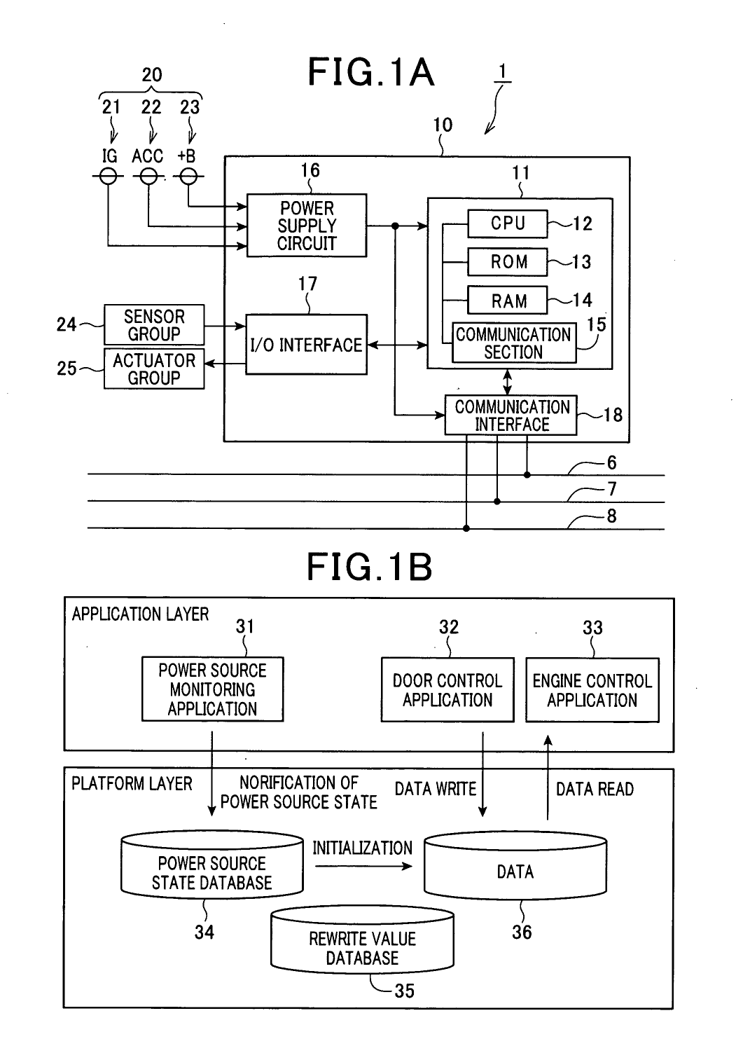

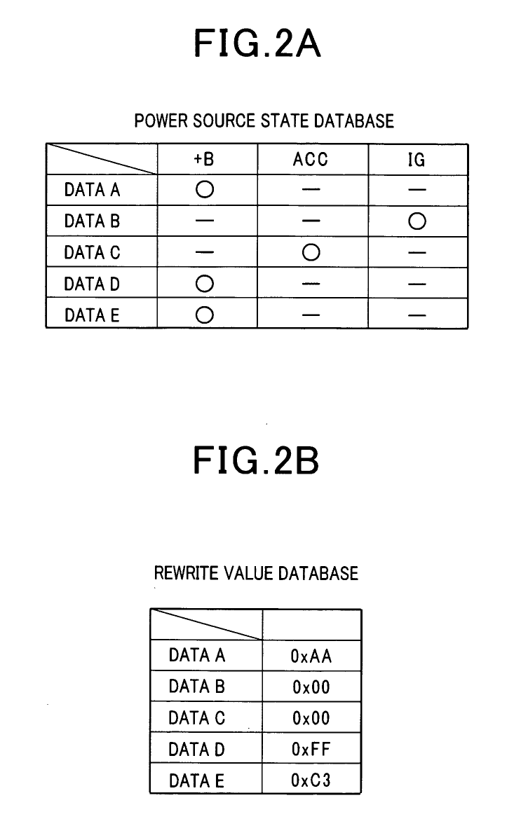

FIG. 1A is a block diagram showing a schematic structure of a vehicle control system 1 including a vehicle control apparatus (referred to as a vehicle control ECU hereinafter) 10 according to an embodiment of the invention. FIG. 1B is an explanatory view showing a software configuration of the vehicle control ECU 10. FIG. 2A is an explanatory view showing a table included in a power source state database 34 included in the vehicle control ECU 10. FIG. 2B is an explanatory view of a table included in a rewrite value database 35 included in the vehicle control ECU 10.

As shown in FIG. 1A, the vehicle control system 1 includes the vehicle control ECU 10, a plurality of power supplies 20, a sensor group 24 including a plurality of different sensors, an actuator group 25 including a plurality of different actuators, and a plurality of communication lines 6 to 8.

The vehicle control ECU 10 includes a microcomputer 11 having a CPU 12, a ROM 13, a RAM 14 and a communication section 15, a power supply circuit 16, an I/O (input/output) interface 17 and a communication interface 18.

The power supply circuit 16 converts electric power received from the plurality of the power sources 20 into a power supply voltage of a predetermined value, and supplies the power supply voltage to the microcomputer 11, the I/O interface 17 and the communication interface 18. The power supply circuit 16 also detects the power supply states (the output voltages, on/off states, and the like) of the respective power sources 20, and sends the detected power supply states to microcomputer 11.

The power sources 20 include an IG (ignition terminal) 21, an ACC (accessory terminal) 22, and a +B (battery terminal) 23. Although these are components supplied with electric power from a vehicle battery (not shown), since their electrical potentials vary at different timings, they are regarded as different power sources.

More precisely, the +B 23 changes to the ON state when it is wired to the power supply circuit 16. However, for the IG 21 or the ACC 22 to change to the ON state, it is necessary to turn on an ignition switch (not shown) or an accessory switch (not shown) in the state where IG 21 and the ACC 22 are wired to the power supply circuit 16.

The I/O interface 17 is connected with the sensor group 24 and the actuator group 25 to relay detection results by the sensor group 24 to the microcomputer 11, and relay commands outputted from the microcomputer 11 to the actuator group 25.

The communication interface 18 is connected with a first communication line 6, a second communication line 7 and a third communication line 8 to perform exchange of communication data between the microcomputer 11 and the communication lines 6 to 8. The first to third communication lines 6 to 8 respectively constitute different in-vehicle LANs.

The CPU 12 of the microcomputer 11 performs various processes in accordance with programs including a vehicle control program stored in the ROM 13. In performing each program, the CPU 12 performs communication with outside through the communication section 15.

The programs executed by the CPU 12 are constituted in a hierarchical structure in which an application layer consisting of programs specific to the system 1 is located on a platform layer consisting of base programs such as operation software. The programs in the application layer can use various functions of the platform layer.

As shown in FIG. 1B, the application layer includes, as application programs, a power source state monitoring application 31 to monitor the power source states, a door control application 32 to control opening and closing of vehicle doors, and an engine control application 33 to control operation of a vehicle engine. The platform layer includes a program to access databases in order to perform writing, reading or rewriting of data with the databases.

Upon detecting that a notification received from the power source state monitoring application 31 shows that a detected change of the power source state is in compliance with a norm described in the power source state database 34, the platform layer performs a process to rewrite the values of the parameter data 36 used by other applications (the door control application 32, engine control application 33, for example) to initial values or fail-safe values. The initial values and the fail-safe values are stored in the rewrite value database 35. The platform layer reads the rewrite values from the rewrite value database 35 as necessary.

The platform layer also performs data exchange with the door control application 32 or engine control application 33 while writing or reading the parameter data 36, when the door control application 32 or engine control application 33 is in operation.

The parameter data 36, which is rewritten by the power source state monitoring application 31, is stored in the RAM 14. The power source state database 34 and the rewrite value database 35 are stored in the ROM 13 or RAM 14.

The parameter data 36 contains a plurality of data items A to E. As shown in FIG. 2A, the power source state database 34 includes a table showing correspondences between the data items A to E and their rewrite timings (rewrite conditions). For example, the rewrite condition of each of the data items A to E is a timing at which a specific one of the power sources 21 to 23 is turned on.

In more detail, the values of the data items A, D and E are rewritten to predetermined write values respectively at a timing when the B23 is changed to the ON state, the value of the data item B is rewritten to a predetermined rewrite value at a timing when the IG 21 is changed to the ON state, and the value of the data item C is rewritten to a predetermined rewrite value at a timing when the ACC 22 is changed to the ON state.

As shown in FIG. 2B, the rewrite value database 35 includes a table showing correspondences between the data items A to E and their values after being rewritten. The rewrite values of the data items A to E may be different from one another or the same as one another.

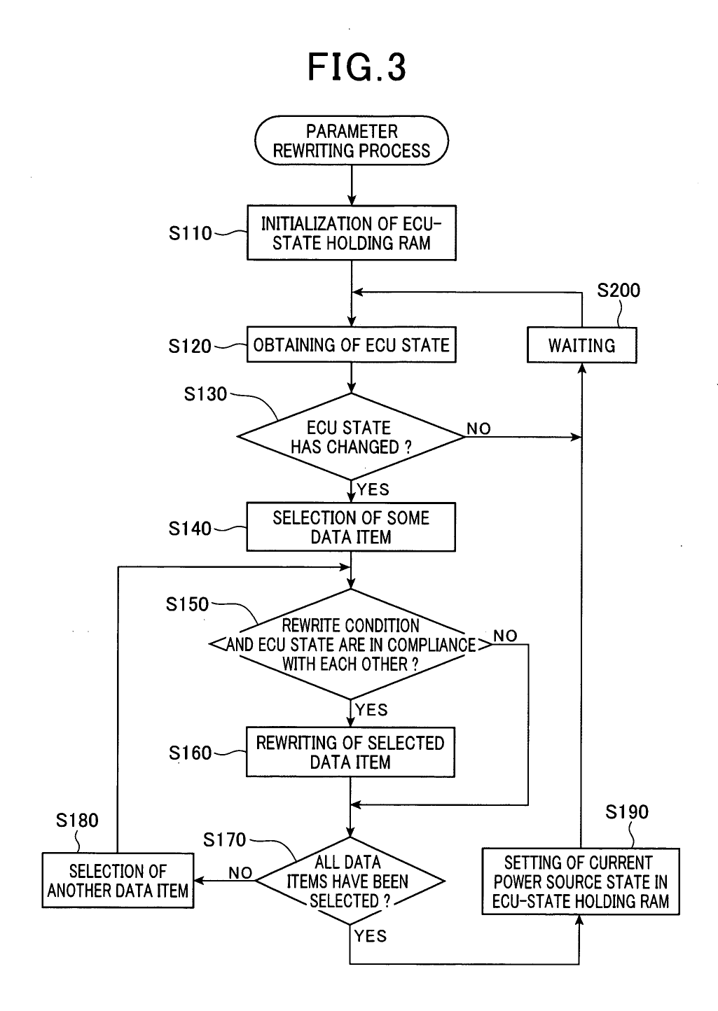

Next, the operation of the vehicle control system 1 when the vehicle control ECU 10 performs the process to rewrite the parameter data 36 by use of the function of the power source state monitoring application 31 is explained with reference to FIG. 3. FIG. 3 is a flowchart showing the parameter data rewriting process executed by the CPU 12 of the vehicle control ECU 10.

The parameter rewriting process begins by initializing the power source state holding RAM at step S110 when the vehicle control ECU 10 is connected to the +B23. More precisely, the parameter rewriting process initializes an area of the RAM 14 at step S110, the area storing the power source state. Here, the term “initialize” means to set the area to the all 0 state (or all OFF state).

Subsequently, the ECU state is obtained at step S120. Here, the term “ECU state” means the electrical potential states of the respective power sources 20. That is, at step S120, the CPU 12 detects whether each of the power sources 21 to 30 is in the ON state or OFF state through the power supply circuit 16, and obtains the detection results as the ECU state.

Next, it is determined whether or not the ECU state has changed at state S130. This determination is made by comparing the currently obtained ECU state with the ECU state stored in the RAM 14.

For example, immediately after this parameter rewriting process is started, the determination result at step S130 is always affirmative, because the ECU state stored in the RAM 14 shows that the power sources 21 to 23 4 are all in the OFF state, while the currently obtained ECU state shows that the +B23 is in the ON state.

If the determination result at step S130 is negative, the process waits for a predetermined time at step S200, and then returns to step S120. If the determination result at step S130 is affirmative, the process proceeds to step S140 to select one of the data items A to E, and then proceeds to step S150 to determine whether or not the rewrite condition of the selected data item and the changed ECU state are consistent with each other. For example, the rewrite condition of the data item A is the change of the +B23 to the ON state as shown in the table of the power source state database 34 shown in FIG. 2A.

If the determination result at step S150 is affirmative, the process proceeds to step S160 to rewrite the selected data item which has determined to satisfy the rewrite condition, and then proceeds to step S170. For example, to rewrite the data item A at step S160, the rewrite value of 0xAA associated with the data item A is read from the rewrite value database 35, and the data item A is rewritten to this value.

On the other hand, if the determination result at step S150 is negative, the process proceeds to step 170 to determine whether or not all the data items have been selected. If the determination result at step S170 is negative, the process proceeds to step S180 to select the data item not yet selected, and returns to step S150 to repeat the above operation.

If the determination result at step S170 is affirmative, the process proceeds to step S190 to store the currently detected ECU state in the RAM 14. Subsequently, the process proceeds to step S200 to wait for a predetermined time, and thereafter proceeds to step S120 in order to repeat steps S120 and the following steps.

The vehicle control system 1 described above provides the following advantages. As explained above, the vehicle control ECU 10 of the vehicle control system 1 repeatedly obtains the vehicle state (ECU state) by performing the parameter rewriting process, determines whether or not the obtained vehicle state has changed in compliance with the rewrite condition stored in the power source state database 34 for each of the parameters (data items), and rewrite the parameter to a corresponding one of the rewrite values associated to the respective parameters.

In the vehicle control system 1, only the parameter(s) satisfying its rewrite condition is rewritten to a predetermined value, and the parameter(s) not satisfying its rewrite condition is not rewritten. Accordingly, according to the vehicle control system 1, when different ECUs are integrated into a single ECU, it is possible to rewrite respective parameters at their correct timings for each of the different ECUs.

The vehicle control ECU 10 may be configured to obtain the voltage state of each of the IG 21, ACC 22 and the +B23 as power sources.

In this case, it is possible to set the rewrite condition in accordance with the output voltage states of the respective power sources for each of the parameters, so that each parameter can be rewritten when the voltage state of at least one of the power source having a close relation to the parameter has changed in compliance with its rewrite condition.

It is a matter of course that various modifications can be made to the above described embodiment as described below.

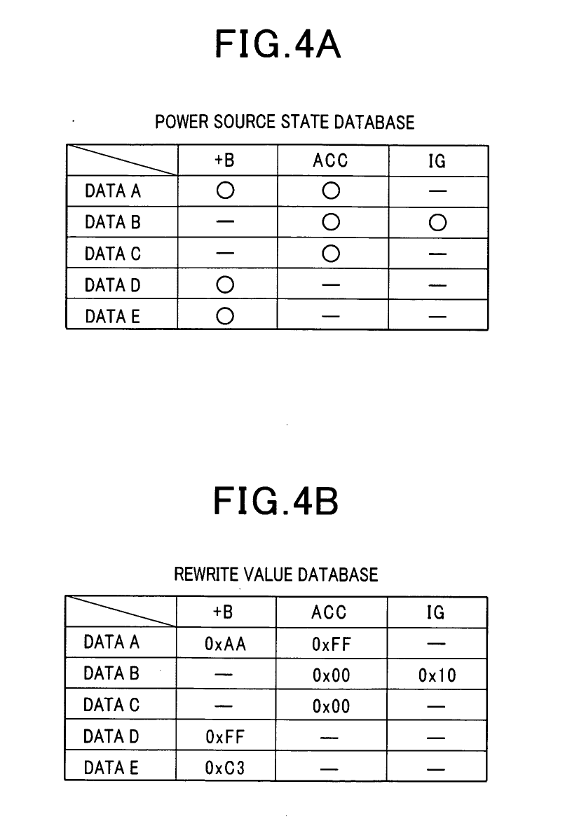

In the above embodiment, one rewrite condition and one rewrite value are set for each one of the data items of the parameter data 36. However, a plurality of rewrite conditions and a plurality of rewrite values may be set for each one of the data items of the parameter data 36 as shown in FIG. 4A.

In the case of FIG. 4A, the rewrite conditions of the data item A include that the ACC 22 or +B23 is turned on, and the rewrite conditions of the data item B include that the IG21 or ACC22 is turned on. Further, as shown in FIG. 4B, a plurality of different rewrite values are associated to each of the different rewrite conditions.

According to the vehicle control system 1 modified as above, the vehicle control ECU 10 can rewrite each parameter to different values depending on the vehicle state (ECU state). For example, this makes it possible to rewrite some one of the parameters to its initial value (all 0 value, for example) when the power of the vehicle is turned on, and to its fail-safe value (intermediate value, for example) when the vehicle enters an abnormal state (when the power of the vehicle is turned off unexpectedly, for example).

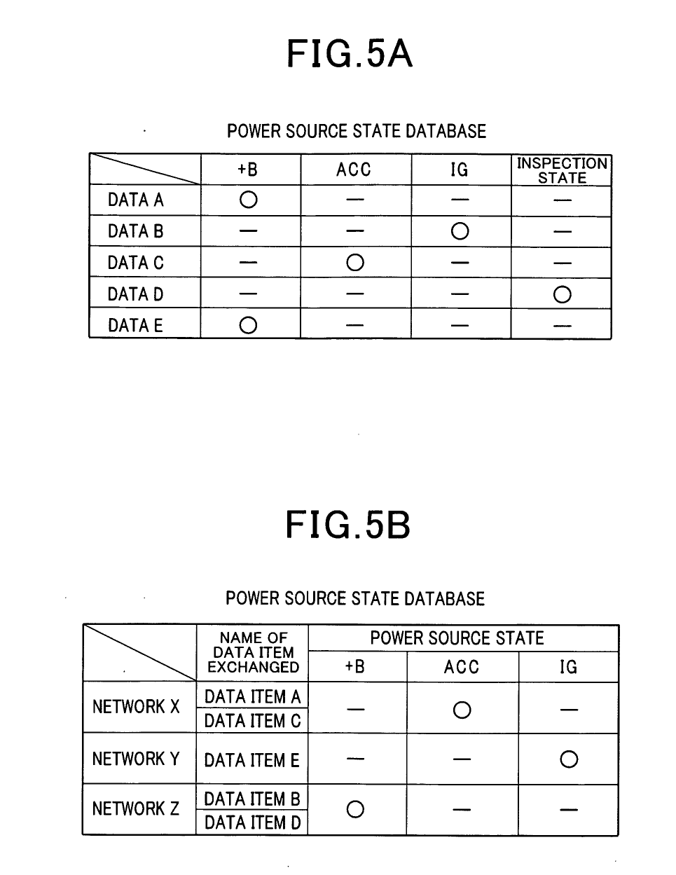

The above embodiment is configured to obtain only the power supply state to the ECU as the vehicle state. However, a vehicle inspection state may be obtained as the vehicle state to determine whether the vehicle is under inspection or not. In this case, the sensor group 24 includes a sensor to detect an inspection device installed to a vehicle, and the vehicle control ECU 10 obtains a detection result by this sensor and stores the detection result in the area for storing the vehicle state in the RAM 14, to thereby provide the power source state database 34 as shown in FIG. 5A.

In the case shown in FIG. 5A, the rewriting condition of the data item D is that the inspection condition is changed to the ON state. According to such a configuration of the vehicle control system, it is possible to perform the parameter rewriting process not only when the power source state has changed but also when a vehicle inspection is started.

In the vehicle control system 1 configured to perform data exchange with different networks X, Y and Z through communication lines 6 to 8 respectively, the rewrite conditions may be set for each of the communication lines 6 to 8 in the power source state database 34 as shown in FIG. 5B.

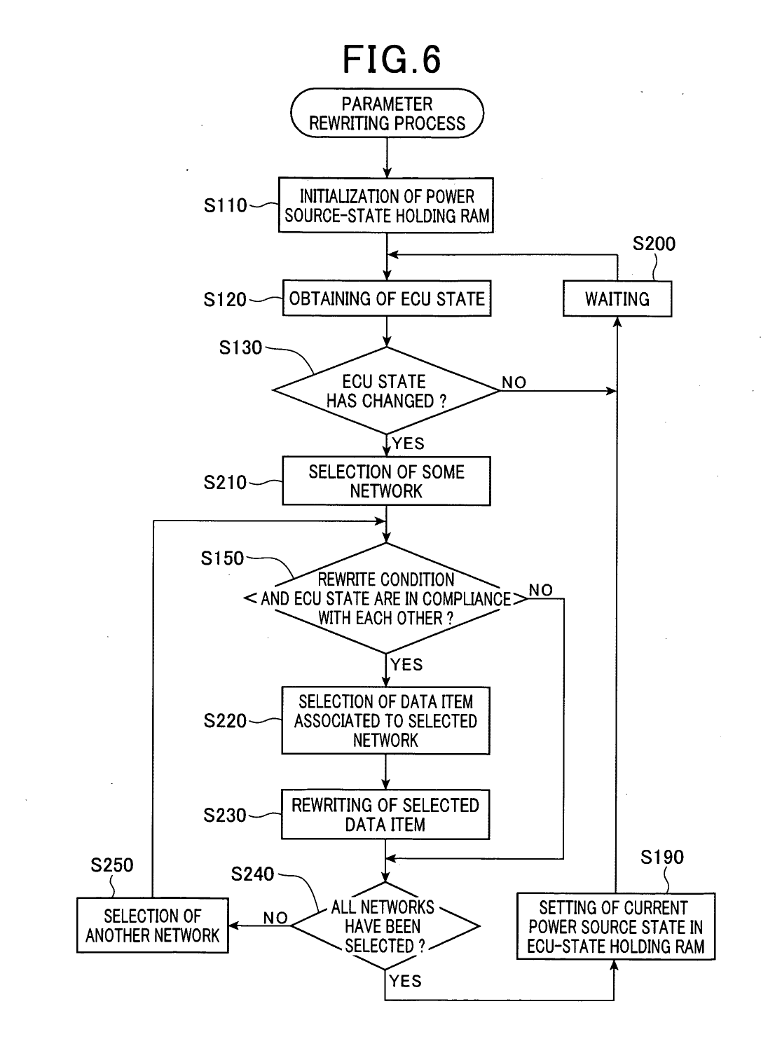

In this case, the parameter data 36 is rewritten collectively for each one of the networks X, Y and Z. The parameter rewriting process in such a case is explained with reference to the flowchart of FIG. 6. This process begins by determining whether or not the ECU state has changed at step S130. If the determination result at step S130 is affirmative, the process proceeds to step S210 to select one of the networks, and then proceeds to step S150 to determine whether or not the changed ECU state is in compliance with the rewriting condition.

If the determination result at step S150 is affirmative, the process proceeds to step S220 to select all the data items of the parameter data 36 assigned to the selected network. For example, if the rewriting condition is determined to be in compliance with the detected ECU state for the network X, the data items A and C assigned to the network X are selected.

Thereafter, the process proceeds to step S230 to rewrite the selected data items, and then proceeds to step S240 On the other hand, if the determination result at step S150 is negative, the process proceeds to step S240 to determine whether or not all the networks have been selected. If the determination result at step S240 is negative, the process proceeds to step S250 to select the network not yet selected, and returns to step S150.

If the determination result at step S240 is affirmative, the process proceeds to step S190 to store the currently detected ECU state in the RAM 14. Subsequently, the process proceeds to step S200 to wait for a predetermined time, and thereafter proceeds to step S120 in order to repeat steps S120 and the following steps. According to the above modification of the vehicle control system 1, when the number of the parameters is changed, the program has to be changed only in the assignment relationship between the parameters and the communication lines 6 to 8, and it is not necessary to change the descriptions regarding the parameters in the power source state database 34, because the rewrite condition is set for each of the network communication lines 6 to 8 in the power source state database 34.

The above explained preferred embodiments are exemplary of the invention of the present application which is described solely by the claims appended below. It should be understood that modifications of the preferred embodiments may be made as would occur to one of skill in the art.

What is claimed is:

1. A vehicle control apparatus to perform vehicle control on a vehicle by issuing commands generated on the basis of results of computations which the vehicle control apparatus performs by use of a plurality of parameters, comprising:
a first section to obtain a vehicle state of the vehicle; and
a second section to make, for each of the plurality of the parameters, a determination whether or not the vehicle state has changed in compliance with a corresponding at least one of rewrite conditions respectively set for the plurality of the parameters, and if the determination is affirmative, rewrite the parameter to a corresponding one of rewrite values respectively assigned to the plurality of the parameters.

2. The vehicle control apparatus according to claim 1, wherein the vehicle control apparatus is configured to perform data exchange with a plurality of in-vehicle networks, and each of the rewrite conditions are set for each of the plurality of the in-vehicle networks.

3. The vehicle control apparatus according to claim 1, wherein the vehicle control apparatus is connected with a plurality of power sources, the first section is configured to obtain an output voltage state of each of the plurality of the power sources as the vehicle state, and each of the rewrite conditions prescribes a value of the output voltage of a corresponding one of the plurality of the power sources as the rewrite value thereof.

4. The vehicle control apparatus according to claim 1, wherein at least one of the plurality of the parameters is set with two or more of the rewrite conditions associated with different rewrite values.

5. The vehicle control apparatus according to claim 1, wherein each of the first and second sections operates in accordance with a vehicle control program stored in a memory of the vehicle control apparatus.
